(19) United States
(12) Patent Application Publication
(10) Pub. No.: US 2001/0014966 A1
(43) Pub. Date: Aug. 16, 2001

(54) Program development method, program development apparatus, storage medium storing program development program and program development program

(75) Inventor: Kenji Numata, Tokyo (JP)

Correspondence Address: FOLEY & LARDNER, Washington Harbour, 3000 K Street, N.W., Suite 500, P. O. Box 25696, Washington, DC, 20007-8696, US

(73) Assignee: NEC CORPORATION

(21) Appl. No.: 09/771,718

(22) Filed: Jan. 30, 2001

(30) Foreign Application Priority Data
Jan. 31, 2000 (JP) 2000-023231

(51) Int. Cl. G06F 9/44

(52) U.S. Cl. 717/1

(57) ABSTRACT

A program development apparatus is provided with a generator and a compiler for generating a program and an event pseudo-generating routine based on a state-transition matrix and event pseudo-generating information, an evaluation chip for executing emulation of the program and the event pseudo-generating routine and an analysis section for starting emulation of the program from a state input as an initial state, for referring to the event pseudo-generating information and for rewriting information memorized in a RAM used in executing the pseudo-generating routine and pseudo-generating an event into information corresponding to an event instructed so as to occur.

### BACKGROUND OF THE INVENTION

1. Field of the Invention

The present invention relates to a program development method, a program development apparatus, a storage medium storing a program development program and a program development program and more particularly to the program development method, the program development apparatus, the storage medium storing the program development program and the program development program suitable to apply to development of a program to be installed in a real-time control system which is controlled at a real-time such as a compact disk player or an image processing apparatus.

The present application claims priority of Japanese Patent Application No. 2000-023231 filed on Jan. 31, 2000, which is hereby incorporated by reference.

2. Description of the Related Art

In a real-time control system, an event that is an impulse (stimulation) from an outside or an inside of the real-time control system, for example, various signals and a state that is a behavior of the real-time control system, for example, waiting to receive various signals are combined complicatedly. Also, there are many processes corresponding to these combinations, namely, many actions that are processes executed by the real-time control system when a specific event occurs under a specific state. As one of techniques for developing a program to be installed in such a real-time control system, there is a program development method using a state-transition matrix. The state-transition matrix is shown by a two-dimensional matrix in which an event and a state are respectively arranged in a row or a column and an action corresponding to an intersection point (cell) of the event and the state and a transition destination after the action are arranged. According to this program development method, though the real-time control system becomes large and becomes complicated, it is possible for an inexperienced person in basic design to execute the basic design and it is also possible to save labor and to shorten a development period.

However, there is a rare case in that an object program developed by the program development method and described by a language (such as a machine language or an assembly language) executable by a CPU (Central Processing Unit) in the real-time control system operates normally from the beginning to the completion.

So, a problem (such as a programming error or a bug) of the object program is usually removed using a program test apparatus described later.

The program test apparatus, for example, is mainly provided with an ICE (In-Circuit Emulator) and a debug control terminal. The ICE, for the object program test, is mainly provided with a debugging circuit in addition to a CPU core for executing a program process, a debugging dedicated terminal in addition to terminals included in a real chip (CPU chip) to be tested actually implemented in a target system when forwarding, an evaluation chip (known good chip) of performance equal to the real chip, a ROM (Read Only Memory) for previously storing the object program to be tested and a RAM used by the evaluation chip when the object program is executed. The evaluation chip is connected with a socket into which the real chip fixed to a substrate forming a hardware of a system to be developed (target system) should be inserted via an emulation probe. The debugging control terminal is connected to the ICE and has various functions for debugging the object program.

A program checker operates the debugging control terminal so as to read the object program from the ROM by the evaluation chip forming the ICE and so as to execute the object program, and thereby processes approximately equal to those of a case in which the target system is actually operated can be executed. Therefore, a problem (such as a bug) in the object program is removed based on various information obtained in the above-mentioned operation and written in the RAM forming the ICE.

Now, when the object program is tested using the conventional program test apparatus, it is confirmed whether a desired process is executed or not by operating various switches or various keys forming hardware of the target system in a case. In this case, it was necessary to repeat a same operation dozens of times in order to confirm that a desired process is normally executed, and therefore, there is a problem in that the operation is troublesome and it takes time too much.

For example, in a CD (Compact Disc) player, in a case of a test for a process for reproducing a second song from the beginning among plural songs stored in a CD, when various switches or various keys are actually operated as a conventional technique, first it is necessary to push a tray key so as to draw a tray from the CD player, to put the CD onto the tray and to push the tray key so as to draw the tray into the CD player, to push a search key two times and then to push a play key so as to play the second song. In other words, plural switches and plural keys are operated plural times in order, and thereby a desired process is executed at last. In this case, in addition to that the operation is troublesome and takes time, it is possible to test the process only after confirming that all processes of the object program before executing the desired process operate normally. Accordingly, there is a problem in that any process can not be tested in any order.

Also, concerning the target system, since the object program and hardware are developed in parallel, hardware used to test the object program is not completely provided with a shape and a function for actual market use; and a prototype in which durability of switches and keys is not considered is usually used. Therefore, there is a possibility in that the switch or the key may become broken when the same operation is repeated dozens of times as described above and it causes a delay in the object program test. Also, when it is waited until hardware of a shape and a function for actual market use is developed, a development period of a target system becomes longer.

So, it is desirable to inspect the object program without using hardware of the target system, however, such a program test apparatus is not yet available on the market at present.

### SUMMARY OF THE INVENTION

In view of the above, it is an object of the present invention to provide a program development method, a program development apparatus, a storage medium storing a program development program and a program development program, capable of executing any process of an object program for a target system without using hardware of the target system simply and in a short time.

According to a first aspect of the present invention, there is provided a program development apparatus used for developing a program to be installed in a system having at least a first central processing and an other component, the program development apparatus including:

a program generating section for generating the program and an event pseudo-generating routine for pseudo-generating the event based on a state-transition matrix and event pseudo-generating information for pseudo-generating a same event as an event which normally occurs based on data or a signal transmitted from the other component to the first central processing unit in the system, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell;

a second central processing unit having a same function as the first central processing unit and for executing emulation of the program and the event pseudo-generating routine; and

an analysis section for starting the emulation of the program from a state input as an initial state and for referring to the pseudo-generating information and rewriting information for pseudo-generating the event memorized in a memory section used in executing the event pseudo-generating routine into information corresponding to the event which is instructed to occur.

Also, according to a second aspect of the present invention, there is provided a program development apparatus used for developing a program to be installed in a system having at least a first central processing and an other component, the program development apparatus including:

a state-transition matrix memory section for memorizing a state-transition matrix, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell;

an event pseudo-generating editor for generating event pseudo-generating information for pseudo-generating a same event as an event which normally occurs based on data or a signal transmitted from other component to a first central processing unit in the system;

a program generating section for generating the program and an event pseudo-generating routine for pseudo-generating the event;

a second central processing unit for having a same function as the first central processing unit and for executing emulation of the program and the event pseudo-generating routine;

an input section for detecting which display position of each event or each state is indicated among a plurality of events and a plurality of states forming the state-transition matrix displayed on a display section and for outputting position information of the display position; and

an analysis section for converting the position information into an event code or a state code corresponding to the position so as to set a state corresponding to the state code as an initial state for starting emulation of the program and for referring to the pseudo-generating information so as to rewrite information memorized in a memory section used in executing the pseudo-generating routine, the information for pseudo-generating an event into information corresponding to the event code.

Also, according to a third aspect of the present invention, there is provided a program development apparatus used for developing a program to be installed in a system having at least a first central processing and an other component, the program development apparatus including:

a state-transition matrix memory section for memorizing a state-transition matrix, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell;

an event pseudo-generating editor for generating event pseudo-generating information for pseudo-generating a same event as an event which normally occurs based on data or a signal transmitted from the other component to a first central processing unit in the system;

a program generating section for generating the program and an event pseudo-generating routine for pseudo-generating the event;

a second central processing unit for having a same function as the first central processing unit and for executing emulation of the program and the event pseudo-generating routine;

an input section for detecting which display position of each event or each state is indicated among a plurality of events and a plurality of states forming the state-transition matrix displayed on a display section so as to output position information of the display position and for generating an input event log including an order of instructed events and an instruction timing of each event; and

a script generating section for generating a script file in which an occurrence timing of each event and a timing at which an element in the system operates in accordance with a specification are descried based on the input event log;

a script analysis section for sequentially outputting position information of each event described in the script file and of a corresponding display area in the state-transition matrix displayed on the display section in order and at an occurrence timing described in the script file; and

an analysis section for converting the position information into an event code or a state code corresponding to the position so as to set a state corresponding to the state code as an initial state for starting emulation of the program and for referring to the pseudo-generating information so as to rewrite information memorized in a memory section used in executing the pseudo-generating routine, the information for pseudo-generating an event into information corresponding to the event code.

In the foregoing third aspect, a preferable mode is one further including:

a script editor for editing the script file based on any one of an event input to be occurred, an occurrence timing of the event and an occurrence frequency.

In the foregoing first, second or third aspect, a preferable mode is one wherein the script file is any one of a timing chart format, a text format and a message sequence chart format.

Also, a preferable mode is one wherein the program includes a main routine for executing a main process of the system and a normal generating event routine for normally generating a corresponding event based on various data and a signal transmitted from the other component to the first central processing unit.

Also, a preferable mode is one wherein the event pseudo-generating information is information of a generating technique in accordance with the event.

Furthermore, a preferable mode is one wherein the event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of the state-transition matrix to another state-transition matrix when the state-transition matrix is layered and a function-call type for calling a function executing a group of processes.

According to a fourth aspect of the present invention, there is provided a program development method used for developing a program to be installed in a system having at least a first central processing and an other component, the program development method including:

a first step of generating the program and an event pseudo-generating routine for pseudo-generating the event based on a state-transition matrix and event pseudo-generating information for pseudo-generating a same event as an event which normally occurs based on data or a signal transmitted from the other component to the first central processing unit in the system, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell; and

a second step of starting emulation of the program from a state input as an initial states of referring to the pseudo-generating information while executing the event pseudo-generating routine and of rewriting information for pseudo-generating the event memorized in a memory section used in executing the event pseudo-generating routine into information corresponding to the event which is instructed to occur.

According to a fifth aspect of the present invention, there is provided a program development method used for developing a program to be installed in a system having at least a first central processing and an other component, and carried out by using:

a state-transition matrix memory section for memorizing a state-transition matrix, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell;

an input section for detecting a display position of which event or state is instructed among a plurality of events or a plurality of states forming the state-transition matrix displayed on a display section and for outputting position information about detected the display position, the program development method including:

a first step of generating event pseudo-generating information for pseudo-generating a same event as an event normally generated based on data or a signal transmitted from the other component to a first central processing unit in the system;

a second step of generating the program and an event pseudo-generating routine for pseudo-generating the event based on the state-transition matrix and the event pseudo-generating information; and

a third step of converting the position information into an event code or a state code corresponding to the position, of starting emulation of the program from a state input as an initial state, of referring to the pseudo-generating information while executing the event pseudo-generating routine and of rewriting information for pseudo-generating the event memorized in a memory section used in executing the event pseudo-generating routine into information corresponding to the event which is instructed to occur.

Also, according to a sixth aspect of the present invention, there is provided a program development method used for developing a program to be installed in a system having at least a first central processing and an other component, and carried out by using:

a state-transition matrix memory section for memorizing a state-transition matrix, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell;

an input section for detecting a display position of which event or state is instructed among a plurality of events or a plurality of states forming the state-transition matrix displayed on a display section and for outputting position information about detected the display position, the program development method including:

a first step of generating event pseudo-generating information for pseudo-generating a same event as an event normally generated based on data or a signal transmitted from the other component to a first central processing unit in the system;

a second step of generating the program and an event pseudo-generating routine for pseudo-generating the event based on the state-transition matrix and the event pseudo-generating information; and

a third step of generating an input event log including an order of instruct events and a timing at which each event is instructed:

a fourth step, based on the input event log, of generating a script file in which an occurrence timing of each event described in the state-transition matrix and a timing at which an element in the system operates in accordance with a specification are described;

a fifth step of sequentially outputting position information of each event described in the script file and of a corresponding display area in the state-transition matrix displayed on the display section in order and at an occurrence timing described in the script file; and

a sixth step of converting the position information into an event code corresponding to the position, of referring to the event pseudo-generating information while executing the event pseudo-generating routine and of rewriting information memorized in a memory section used by the event pseudo-generating routine, the information for pseudo-generating an event into information corresponding to the event code.

In the foregoing sixth aspect, a preferable mode is one that wherein further including:

a seventh step of editing the script file based on any one of an event input to be occurred, an occurrence timing of the event and an occurrence frequency.

In the foregoing fifth or sixth aspects, a preferable mode is one wherein the script file is any one of a timing chart format, a text format and a message sequence chart format.

In the foregoing fourth, fifth or sixth aspect, a preferable mode is one wherein the program includes a main routine for executing a main process of the system and a normal generating event routine for normally generating a corresponding event based on various data and a signal transmitted from the other component to the first central processing unit.

Also, a preferable mode is one wherein the event pseudo-generating information is information of a generating technique in accordance with the event.

Furthermore, a preferable mode is one wherein the event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of the state-transition matrix to another state-transition matrix when the state-transition matrix is layered and a function-call type for calling a function executing a group of processes.

According to a seventh aspect of the present invention, there is provided a program development program for causing a computer to carry out a program development method used for developing a program to be installed in a system having at least a first central processing and an other components the program development method including:

a first step of generating the program and an event pseudo-generating routine for pseudo-generating the event based on a state-transition matrix and event pseudo-generating information for pseudo-generating a same event as an event which normally occurs based on data or a signal transmitted from the other component to the first central processing unit in the system, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell; and

a second step of starting emulation of the program from a state input as an initial state, of referring to the pseudo-generating information while executing the event pseudo-generating routine and of rewriting information for pseudo-generating the event memorized in a memory section used in executing the event pseudo-generating routine into information corresponding to the event which is instructed to occur.

According to a eighth aspect of the present invention, there is provided a program development program for causing a computer to carry out a program development program for causing a computer to carry out A program development method used for developing a program to be installed in a system having at least a first central processing and an other component, the program development method including:

a state-transition matrix memory section for memorizing a state-transition matrix, wherein the state-transition matrix has a plurality of cells, each of the cells defined by a state in which the system to be a subject of a program development is enabled to be and an event which is an impulse from an outside or an inside of the system and further wherein a content of a process to be executed by the system and a state of a transition destination to be transited when a corresponding event occurs under a corresponding state are described in each the cell;

an input section for detecting a display position of which event or state is instructed among a plurality of events or a plurality of states forming the state-transition matrix displayed on a display section and for outputting position information about detected the display position;

a first step of generating event pseudo-generating information for pseudo-generating a same event as an event normally generated based on data or a signal transmitted from the other component to a first central processing unit in the system;

a second step of generating the program and an event pseudo-generating routine for pseudo-generating the event based on the state-transition matrix and the event pseudo-generating information; and

a third step of converting the position information into an event code or a state code corresponding to the position, of starting emulation of the program from a state input as an initial state, of referring to the pseudo-generating information while executing the event pseudo-generating routine and of rewriting information for pseudo-generating the event memorized in a memory section used in executing the event pseudo-generating routine into information corresponding to the event which is instructed to occur.

With the above configurations, it is possible to test any process of an object program of a target system simply and in a short time in any order without using hardware of the target system. As a result, it is possible to shorten a development period of the target system.

Also, emulation of a program is started from a state input as an initial state, an event pseudo-generating information is referred to and information memorized in a memory section used in executing an event pseudo-generating routine, the information for pseudo-generating an event is rewritten into information corresponding to an event instructed so as to occur. Therefore, in spite of a process which is first executed after operating a plurality of switches or keys in order, it is possible to test any process of the object program of the target system simply and in short time in any order without using hardware of the target system.

Furthermore, an input section generates an input event log, a script generating section generates a script file based on the input event log, a script analysis section sequentially outputs position information of each event described in the script file and of a corresponding display area in a state-transition matrix in order and at an occurrence timing described in the script file. Therefore, since it is possible to execute to generate the script file and emulation approximately at a same time and it is possible to shorten a time for generating and correcting the script file, it is possible to shorten the development period of the object program. Also, in spite of that the hardware of the target system is not completed or in spite of a process which is first executed after operating a plurality of switches or keys in order a plurality of times, it is possible to execute emulation automatically and repeatedly any times without actually operating a switch or a key and it is possible to shorten a development period of the object program. Further, though a degradation caused by a result of a program test and a correction for the object program based on the result occurs and the object program is re-tested widely, it is possible to pseudo-generate a plurality of events covering a wide area automatically by generating a script file. As a result, it is possible to shorten the development period of the object program.

Therefore, it is possible to shorten the development period of the target system.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing a configuration of a program development apparatus according to a first embodiment of the present invention;

FIG. 2 is a schematic block diagram showing a configuration of an in-circuit emulator and a target system;

FIG. 3 is a state-transition matrix of operation of a CPU in a CD player which is an example of the target system;

FIG. 4 is an example of a part of a main routine described in C language;

FIG. 5 is an example of a part of an event pseudo-generating routine described in C language;

FIG. 6 is a view showing an example of an emulation mode screen displayed on a display section in a man-machine interface according to the first embodiment of the present invention; and

FIG. 7 is a block diagram showing a configuration of a program development apparatus according to a second embodiment of the present invention.

### DETAILED DESCRIPTION OF THE PREFERRED EMBODIMENTS

Best modes for carrying out the present invention will be described in further detail using various embodiments with reference to the accompanying drawings.

### First Embodiment

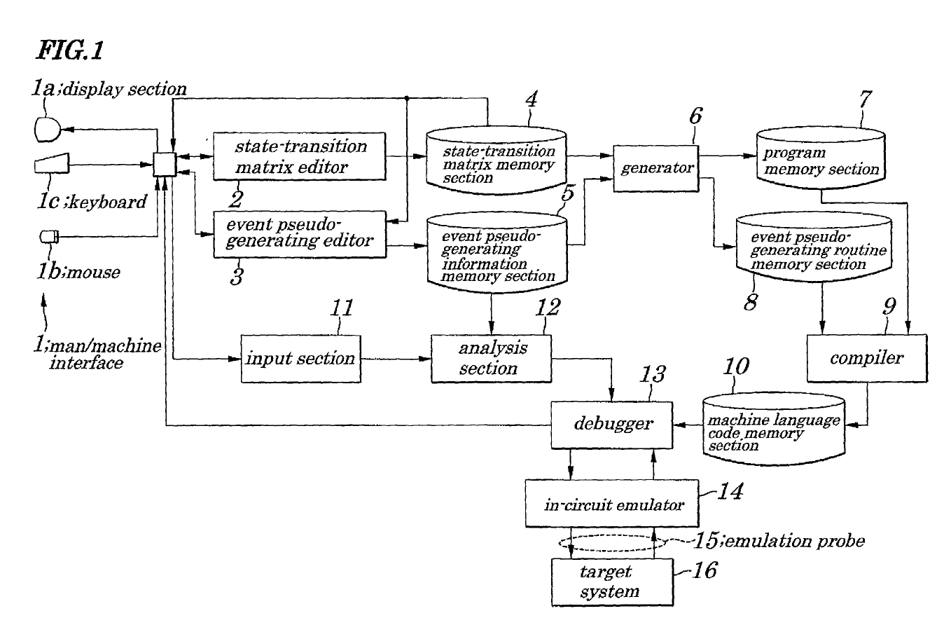

FIG. 1 is a block diagram showing a configuration of a program development apparatus according to the first embodiment of the present invention.

The program development apparatus according to the first embodiment, as shown in FIG. 1, is mainly provided with a man-machine (MMI) interface 1, a state-transition matrix editor 2, an event pseudo-generating editor 3, a state-transition matrix memory section 4, an event pseudo-generating information memory section 5, a generator 6, a program memory section 7, an event pseudo-generating routine memory section 8, a compiler 9, a machine language code memory section 10, an input section 11, an analysis section 12, a debugger 13 and an in-circuit emulator 14. The in-circuit emulator 14 is connected to a target system 16 via an emulation probe 15.

The man-machine interface 1 is provided with a display section 1a, a mouse 1b, a keyboard 1c and a like. A user operates the mouse 1b and the keyboard 1c so as to input information (such as a state, an event, an action and a transition destination) necessary to generate a state-transition matrix. Also, in order to execute an emulation for each event based on a state-transition matrix of a real-time control system designed using the state-transition matrix by the in-circuit emulator 14, a cursor is moved by the cursor key of the mouse 1b or the keyboard 1c in an event display area displayed in the display section 1a and a cursor key of the mouse 1b or the keyboard 1c is pushed, and thereby the man-machine interface 1 is used to indicate an input of the event and an emulated result supplied from the debugger 13 is displayed on the display section 1a.

The state-transition matrix editor 2 generates and edits a state-transition matrix based on the state, the event, the action, the transition destination or a like input via the man-machine-interface 1 and memorizes information concerning the state-transition matrix in the state-transition matrix memory section 4. The event pseudo-generating editor 3, in order to pseudo-generate a same event as the event generated based on a signal corresponding to the operation supplied from the target system by operating various keys, switches or a like of the target system or based on various data or signals transmitted from elements of another CPU or a semiconductor device, by detecting that the cursor is moved, cursor key of the mouse 1b or the keyboard 1c in the display area of the event in the state-transition matrix displayed on the display section 1a and a left button of the mouse 1b is clicked or a return key is pushed, information concerning the state-transition matrix memorized in the state-transition matrix memory section 4 is referred based on information (such as each event generating technique) input via the man-machine interface 1 necessary for pseudo-generating input and event pseudo-generating information which is information concerning to an event to be pseudo-generated is generated and is memorized in the event pseudo-generating information memory section 5. Both of the state-transition matrix memory section 4 and the event pseudo-generating information memory section 5 are storage media having large memory capacities, for example, a semiconductor memory such as a RAM, a FD (a Floppy Disc) and a HD (a Hard Disk), and information of the state-transition matrix and the event pseudo-generating information are respectively stored in the storage media.

The generator 6, based on information concerning the state-transition matrix read from the state-transition matrix memory section 4 and the event pseudo-generating information read from the event pseudo-generating information memory section 5, automatically generates a program (source program) described in a programming language, for example, in C language or a like to be installed in the target system 16 and memorized in the program memory section 7. The generator 6, also based on the event pseudo-generating information read from the event pseudo-generating information memory section 5, automatically generates an event pseudo-generating routine described in a programming language similar the source program and memorizes the event pseudo-generating routine in the event pseudo-generating routine memory section 8. The source program includes a main routine for executing main processes of the target system and an event normal generating routine, based on a signal supplied from the target system 16 by operating various keys, various switches or a like forming the target system 16 and corresponding to the operation and based on various data and various signals transmitted from elements such as another CPU and a semiconductor device, for detecting which key or which switch is operated or which element transmits data and a signal and notifying the main routine of that, namely, for normally generating an event. Each of the program memory section 7 and the event pseudo-generating routine memory section 8 is a semiconductor memory such as a RAM or a storage medium of a large memory capacity such as a FD or a HD. The program memory section 7 and the event pseudo-generating routine memory section 8 respectively memorize the source program and the event pseudo-generating routine.

The compiler 9 converts the source program read from the program memory section 7 in to an object program described in a machine language executable by the CPU in the target system 16 and memorize the object program in the machine language code memory section 10. The compiler 9 also converts the event pseudo-generating routine read from the event pseudo-generating routine memory section 8 and described in a programming language into the event pseudo-generating routine described in a machine language similar to the object program and memorizes the event pseudo-generating routine in the machine language code memory section 10. The machine language code memory section 10 is a semiconductor memory such as a RAM or a storage medium of a large memory capacity such as a FD or a HD and memorizes the object program and the event pseudo-generating routine described in the machine language.

The input section 11 detects a position of a cursor when an operator moves the cursor to a display area such as an event and a state in the state-transition matrix displayed on the display section 1a and clicks the left button of the mouse 1b or pushes the return key, of the keyboard 1c and supplies position information in this case to the analysis section 12. In other words, the input section 11 in the first embodiment functions as a position detecting section for an event, a state or a like.

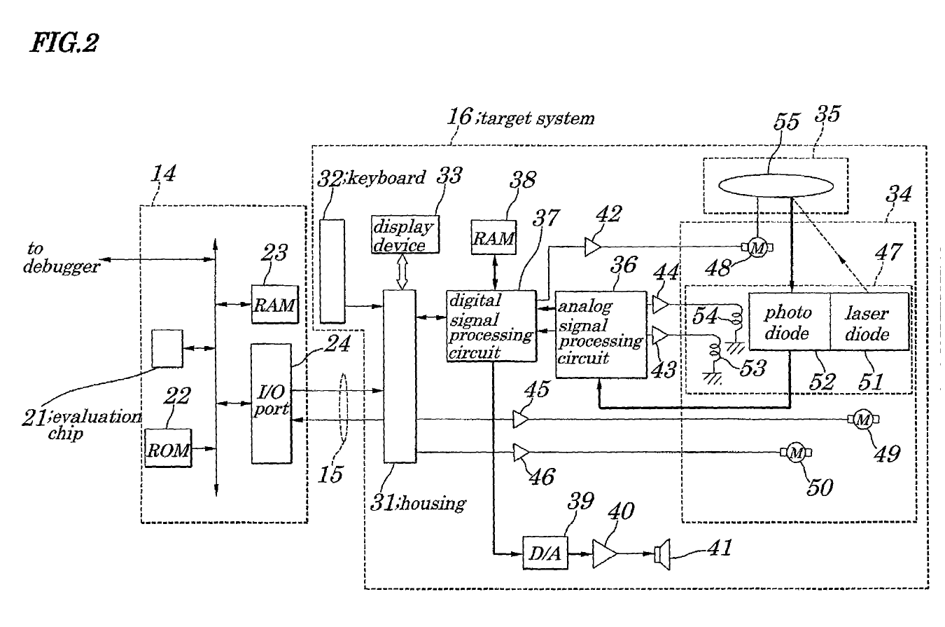

The analysis section 12 converts the position information supplied from the input section 11 into an event coder a state code or a like. The analysis section 12 also controls the debugger 13 so as to set a state corresponding to the state code as an initial state for starting emulation of the object program in the in-circuit emulator 14 and refers to the event pseudo-generating information read from the event pseudo-generating information memory section 5 based on the event code and controls the debugger 13 and re-writes information used by the event pseudo-generating routine memorized in a predetermined memory area of a RAM 23 (FIG. 2) in the in-circuit emulator 14, and thereby pseudo-generates an event corresponding to the event code.

The debugger 13, in order to control the in-circuit emulator 14 and debug the object program, has a function for setting plural break points for temporarily breaking (break) after executing the object program in routine units, a function for displaying contents of an internal resistor in an evaluation chip 21 (FIG. 2) in the in-circuit emulator 14 on the display section 1a, a function for displaying contents of the RAM 23 in the in-circuit emulator 14 on the display section 1a and for changing the contents and a function of a tracer for continuously listing contents of an internal register in the evaluation chip 21 and a like in accordance with a flow of the object program.

Next, explanations will be given of a configuration of the in-circuit emulator 14 and the target system 16 with reference to FIG. 2.

The in-circuit emulator 14 is mainly provided with the evaluation chip 21, a ROM 22, the RAM 23 and an I/O port 24. The evaluation chip 21, for the object program test, is provided with a circuit for debugging in addition to a CPU core for processing a program, a terminal for only debugging in addition to terminals of a real chip and has a function equal to the real chip. The ROM 22 memorizes the object program memorized in the machine language code memory section 10 and the event pseudo-generating routine described in the machine language. The RAM 23 is used while the evaluation chip 21 executes the object program and a part of contents of the RAM 23 is re-written by the debugger 13. The I/O port 24 is connected to the target system 16 via the emulation probe 15, and various signals transmitted between the evaluation chip 21 and the target system 16 are input and output.

The target system 16 is an example of a CD player and is mainly provided with a housing 31, a keyboard 32, a display device 33, a mechanism 34, a tray 35, an analog signal processing circuit 36, a digital signal processing circuit 37, a RAM 38, a D/A converter 39, an amplifier 40, a speaker 41 and driver 42 to driver 46. The target system 16 is connected with the in-circuit emulator 14 via the emulation probe 15 by engaging the housing 31 with a CPU socket provided at a top of the emulation probe 15. The keyboard 32 is provided with various switches and keys such as a power switch, a play key and a stop key. The display device 33 displays a passing time, a track number and a like of music.

The mechanism 34 is mainly provided with an optical pickup 47 for reading digital information memorized by pitting on a signal record surface of a CD using a laser beam, a spindle motor 48 for rotationally driving the CD 55 at a constant linear velocity, a tray opening and shutting motor 49 controlled by the evaluation chip 21 via the I/O port 24, the emulation probe 15, the housing 31 and the driver 45 and for opening and shutting the tray 35 and a field motor 50 controlled by the evaluation chip 21 via the I/O port 24, the emulation probe 15, the housing 31 and the driver 46 and for moving the optical pickup 47 in a radius direction of the CD 55.

The optical pickup 47 is mainly provided with a laser diode 51 for irradiating a laser beam of a predetermined wavelength on the signal record surface of the CD 55, a photo diode 52 for converting a reflected light from a pit formed on the signal record surface of the CD 55 into an electrical reading signal, a focus coil 53 for matching a focus of the laser beam with the pit formed on the signal record surface of the CD 55 and a tracking coil 54 for tracking the laser beam to a string of pits formed on the signal record surface of the CD 55.

The analog signal processing circuit 36 generates a focus error signal and a tracking error signal from the reading signal supplied from the optical pickup 47, controls the focus coil 53 and the tracking coil 54 via the driver 43 and the driver 44 based on the focus error signal and the tracking error signal and amplifies the reading signal so as to output it as an RF signal. The digital signal processing circuit 37 is controlled by the evaluation chip 21 via the I/O port 24, the emulation probe 15 and the housing 31, generates an EFM (Eight to Fourteen Modulation) signal of digital data by shaping a waveform of the RF signal supplied from the analog signal processing circuit 36, executes processes such as a modulation, a code error correction and a compensation for the EFM signal using the RAM 38 so as to convert the EFM signal into a digital audio data and controls the spindle motor 48 via the driver 42. The D/A converter 39 converts the digital audio data into an analog sound signal supplied from the digital signal processing circuit 37. The amplifier 40 amplifies the analog sound signal supplied from the D/A converter 39 so as to emit a sound from the speaker 41.

Next, description will be given with respect to an operation of the program development apparatus according to the first embodiment as described above. First, the target system 16 as a CD player is provided with various functions for reproducing music or a like based on the digital information recorded in the signal record surface of the CD 55 using pits. In the first embodiment, it is assumed that a serial processing is tested in the object programs as described later.

First, in a state in that a power is supplied to the target system 16, all of the spindle motor 48, the tray opening and shutting motor 49 and field motor 50 are stopped and the tray 35 on which no CD 55 is put is in a state drawn into the CD player, when the operator pushes the tray key, the tray 35 is drawn out. Then, the operator puts the CD 55 on the tray 35 and then pushes the tray key again. With this operation, the tray 35 is drawn into the CD player, and then a TOC (Table Of Contents) which is an index of the CD 55 recorded in the most internal circumference of the CD 55 (Table of Contents) is read, for example, a time code of all music is displayed on the display device 33 and it becomes in a waiting state.

Then, the operator pushes the search key two times successively, and then when the operator pushes the play key, a second piece of music is started. Therefore, the operator confirms that the second piece is normally reproduced, and then pushes the stop key. Hereby, all of the spindle motor 48, the tray opening and shutting motor 49 and the field motor 50 are stopped, and therefore the second piece of music is stopped, and the tray 35 on which the CD 55 is put becomes in a state drawn into the CD player.

Then, when the operator pushes the tray key, the tray 35 is drawn out, and therefore, the operator pushes the tray key again after removing the CD 55 from the tray 35. With this operation, the tray 35 is drawn into the CD player and no CD 55 is put in the tray 35, and therefore, the TOC is not read, all the spindle motor 48, the tray opening and shutting motor 49 and the field motor 50 are stopped and the tray 35 on which no CD 55 is put is drawn into the CD player, namely, it becomes in the initial state.

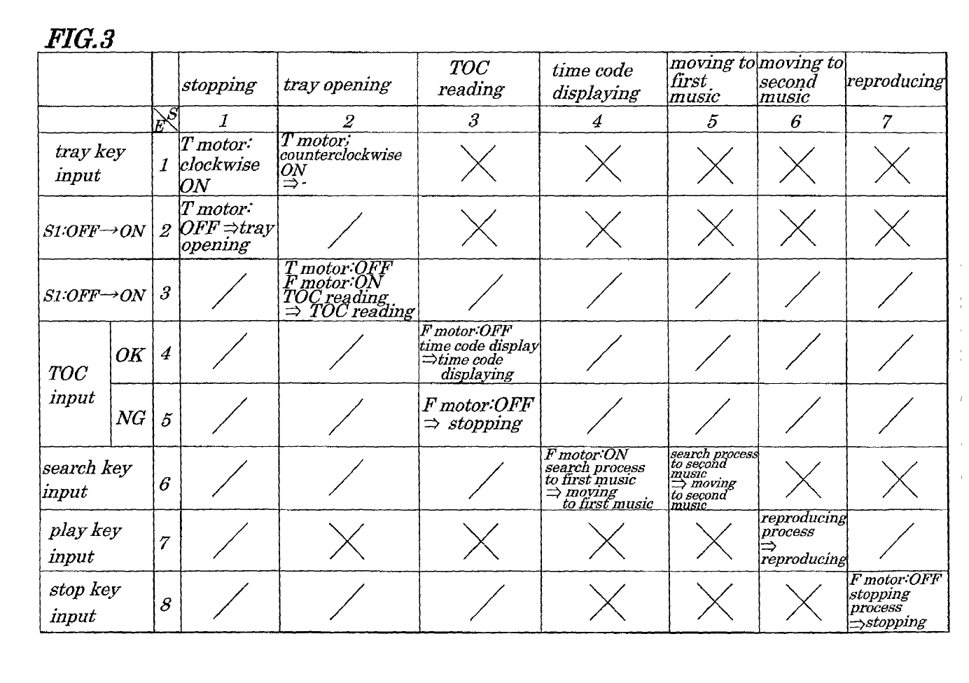

The operator operates the mouse 1b and the keyboard 1c by referring to display screen of the display section 1a constituting the man-machine interface 1, and inputs information (such as a state, an event, an action and a transition point) required to generate a state-transition matrix shown in FIG. 3 based on the operation of the target system 16. With this operation, the state-transition matrix editor 2 generates the state-transition matrix shown in FIG. 3, displays the state-transition matrix on the display section 1a constituting the man-machine interface 1, and memorizes information concerning the state-transition matrix in a predetermined memory area in the state-transition matrix memory section 4.

In FIG. 3, a T motor and an F motor respectively correspond to the tray opening and shutting motor 49 and the field motor 50 in FIG. 2, and a symbol S1 and a symbol S2 correspond to a sensor (not shown in FIG. 2) for detecting that the tray 35 is completely drawn out and a sensor (not shown in FIG. 2) for detecting that the tray 35 is completely drawn into the CD player. Also, it is assumed that the tray 35 is drawn out when the tray opening and shutting motor 49 is driven clockwise and the tray 35 is drawn into the CD player when the tray opening and shutting motor 49 is driven counterclockwise.

In a highest row in FIG. 3, “stopping” indicates a state (hereafter, called “state 1”) in that the spindle motor 48, the tray opening and shutting motor 49 and the field motor 50 are stopped and the tray 35 is drawn into the CD player or the opening and shutting motor 49 is driven clockwise, “tray opening” indicates a state (hereafter, called “state 2”) in that the spindle motor 48, the tray opening and shutting motor 49 and the field motor 50 are stopped and the tray 35 is drawn out from the CD player or the opening and shutting motor 49 is driven counterclockwise, “TOC reading” indicates a state (hereafter, called “state 3”) in that the tray 35 is drawn into the CD player, the tray opening and shutting motor 49 is stooped, both of the spindle motor 48 and the field motor 50 are driven and the TOC receded in the most internal circumference of the CD 55 is read, “time record display” indicates a state (hereafter, called “state 4”) in that the tray 35 is drawn into the CD player, all of the spindle motor 48, the tray opening and shutting motor 49 and the field motor 50 are stopped and time records of all pieces of music are displayed on the display device 33.

Similarly, in the highest row in FIG. 3, “moving to first piece of music” indicates a state (hereafter, called “state 5”) in that the tray 35 is drawn into the CD player, the tray opening and shutting motor 49 is stopped, the spindle motor 48 and the field motor 50 are driven and a top of the first piece of music is retrieved, “moving to second piece of music” indicates a state (hereafter, called “state 6”) in that the tray 35 is drawn into the CD player, the tray opening and shutting motor 49 is stopped, the spindle motor 48 and the field motor 50 are driven and a top of a second piece of music is retrieved, and “reducing” indicates a state (hereafter, called “state 7”) in that the tray 35 is drawn into the CD player, the tray opening and shutting motor 49 is stopped, the spindle motor 48 and the field motor 50 are driven and the second piece of music is reproduced.

Also, in a most left column in FIG. 3, “tray key input” indicates an event (hereinafter, called “event 1”) in that a signal corresponding to the tray key is input by pushing the tray key instructing to open and shut the tray 35 by the user, “S1: OFF→ON” indicates an event (hereinafter, called “event 2”) in that a detection signal of a corresponding sensor is changed from OFF to ON by that the tray 35 is completely drawn out, “S2: OFF→ON” indicates an event (hereinafter, called “event 3”) in that a detection signal of a corresponding sensor is changed from OFF to ON by that the tray 35 is completely drawn into the CD player, “TOC input: OK” (hereinafter, called “event 4”) in that a notification showing that reading of the TOC recorded in the most internal circumference is normally finished by the digital signal processing circuit 37 is supplied since the CD 55 exists in the CD player, “TOC input: NG” (hereinafter, called “event 5”) in that a notification showing that reading of the TOC recorded in the most internal circumference is abnormally finished by the digital signal processing circuit 37 is supplied since the CD 55 exists in the CD player.

Similarly, in the most left column in FIG. 3, “search key input” indicates an event (hereinafter, called “event 6”) in that a signal corresponding to a search key by pushing the search key instructing to retrieve a top of a next piece of music, “play key input” indicates an event (hereinafter, called “event 7”) in that a signal corresponding to a play key is input by pushing the play key instructing to reproduce a piece of music by the user, and “stop key input” indicates an event (hereinafter, called “event 8”) in that a signal corresponding to a stop key is input by pushing the stop key instructing to stop the piece of music being reproduced.

“Event 1” and “event 6” to “event 8” are called a message-type event indicating that a start message is received from other tasks or other devices, “event 2” and “event 3” are called a flag-type event indicating that a variable or a variation of input and output is read, and “event 4” and “event 5” are called an interrupt-type event indicating that an interrupt is received from the outside.

Next, in the state-transition matrix in FIG. 3, when it is assumed that an intersection (cell) of an event and a state, for example, an intersection of “state 1” and “event 2” is indicated by a cell (1, 2), a description of each cell shows following contents. First, in a cell (1, 1), “T motor: clockwise ON” indicates an action for driving the tray opening and shutting motor 49 in order to draw the tray 35 out in the “state 1” in that all of the spindle motor 48, the tray opening and shutting motor 49 and the field motor 50 are stopped and the tray 35 is drawn into the CD player in accordance with occurrence of the “event 1” in that a signal corresponding to the tray key by pushing the tray key by the user, namely, indicates that the “state 1” remains.

In a cell (1, 2), “T motor: OFF” indicates an action for stopping drive of the tray opening and shutting motor 49 in order to finish drawing the tray 35 out in the “state 1” in that the tray opening and shutting motor 49 is driven clockwise in accordance with occurrence of the “event 2” in that a detection signal corresponding to the sensor is changed from OFF to ON by drawing the tray 35 out completely. Also, in the cell (1, 2), “=> tray opening” indicates that a transition destination is “state 2”.

In a cell (1, 3), “/” indicates that no action is executed and no state is transited. A meaning of “/” is similar in other cells, and therefore, no explanation thereof is given.

In a cell (2, 1), “T motor: counterclockwise rotation ON” indicates an action for driving the tray opening and shutting motor 49 counterclockwise in order to draw the tray 35 into the CD player in the “state 2” in that all of the spindle motor 48, the tray opening and shutting motor 49 and the field motor 50 are stopped and the tray 35 is drawn out in accordance with an occurrence of the “event 1” in that a signal corresponding to the tray key is input by pushing the tray key by the user. Also, in a cell (2, 1), “=>-” indicates that a current state, namely, the state 2 remains.

In a cell (2, 3), “T motor: OFF, F motor: ON, TOC reading” indicates an action for driving the field motor 50 while the tray opening and shutting motor 49 is stopped driving and for requiring to read the TOC to the digital signal processing circuit 37 in order to finish drawing the tray 35 into and in order to read the TOC recorded in the most internal circumference of the CD 55 in the “state 2” in that the tray opening and shutting motor 49 is counterclockwise in accordance with an occurrence of the “event 3” in that a detection signal of a corresponding sensor is changed from OFF to ON by completely drawing the tray 35 into the CD player. Also, in a cell (2, 3), “=> TOC reading” is that a transition destination is the “state 3”.

In a cell (2, 7), “X” indicates that any action is executed is executed in accordance with occurrences of the “state 2” and the “state 7” when the object program is completed or no action is executed and no state is transited at a current step. A meaning of “X” is similar in other cells, and therefore, no explanation thereof will be given.

In a cell (3, 4), “F motor: OFF, time record display” indicates an action for stopping driving the field motor 50 and for taking a time record of all pieces of music supplied from the digital signal processing circuit 37 so as to display the time record on the display device 33 in the “state 3” in that the tray 35 is drawn into the CD player, the tray opening and shutting motor 49 is stopped, both of the spindle motor 48 and the field motor 50 are driven and the TOC recorded in the most internal circumference of the CD 55 is read in accordance with an occurrence of the “event 4” in that a notification showing that the TOC recorded in the most internal circumference is read completely and normally since the CD 55 exists in the CD player is supplied. Also, in a cell (3, 4), “=> time record displaying” indicates that a transition destination is the “state 4”.

In a cell (3, 5), “F motor: OFF” indicates an action for stopping driving the field motor 50 and for stopping driving the field motor 50 in the “state 3” in that the tray 35 is drawn into the CD player, the tray opening and shutting motor 49 is stopped, both of the spindle motor 48 and the field motor 50 are driven and the TOC recorded in the most internal circumference of the CD 55 is read in accordance with an occurrence of the “event 5” in that a notification showing that reading of the TOC recorded in the most internal circumference is abnormally since the CD 55 does not exist in the CD player is supplied. Also, in a cell (3, 5), “=> stopping” indicates that a transition destination is the “state 1”.

In a cell (4, 6), “F motor: ON, first music search process” indicates an action for driving the field motor 50 and for requiring a search process of a top of a first piece of music to the digital signal processing circuit 37 in order to retrieve a top of the first piece of music in the “state 4” in that the tray 35 is drawn into the CD player, all of the spindle motor 48, the tray opening and shutting motor 49 and the field motor 50 are stopped and the time record of all pieces of music is displayed on the display device 33 in accordance with an occurrence of the Also, in a cell (4, 6), “→moving to first piece of music” indicates that an transition destination is the “state 5”.

In a cell (5, 6), “second music search process” indicates an action for requiring a search process of requiring a search process of a top of a second piece of music to the digital signal processing circuit 37 in order to retrieve the top of the second piece of music in the “state 5” in that the tray 35 is drawn into the CD player, the tray opening and shutting motor 49 is stopped, both of the spindle motor 48 and the field motor 50 are driven and the top of the first piece of music in accordance with an occurrence of the “event 6” in that a signal corresponding to the search key is input by pushing the search key by the user. Also, in a cell (5, 6), “=> moving to second music” indicates that an transition destination is the “state 6”.

In a cell (6, 7), “reproducing process” indicates an action for requiring a reproducing process of the second piece of music to the digital signal processing circuit 37 in order to reproduce the second piece of music in the “state 6” in that the tray 35 is drawn into the CD player, the tray opening and shutting motor 49 is stopped, both of the spindle motor 48 and the field motor 50 are driven and the second piece of music is retrieved in accordance with an occurrence of the “event 7” in that a signal corresponding to the play key is input by pushing the play key by the user. Also, in a cell (6, 7), “=> reproducing” indicates that a transition destination is the “state 7”.

In a cell (7, 8), “F motor: OFF, stopping process” indicates an action for stopping drive of the field motor 50 and for requiring a stopping process of reproducing of the second piece of music to the digital signal processing circuit 37 in order to stop reproducing the second piece of music in the “state 7” in that the tray 35 is drawn into the CD player, the tray opening and shutting motor 49 is stopped, both of the spindle motor 48 and the field motor 50 are driven and the second piece of music is reproduced in accordance with an occurrence of the “event 8” in that a signal corresponding to the stop key is input by pushing the stop key by the user. Also, in a cell 7, 8), “=> stopping” indicates that a transition destination is the “state 1”.

Next, the operator instructs an input of the event not by actually operating the tray key and the search key forming the keyboard 32 of the target system 16 but by moving the cursor on the display area of the state-transition matrix displayed on the display section 1a with the cursor key of the mouse 1b and the keyboard 1c so as to pseudo-generate the event and, in order to execute an emulation for each event with the in-circuit emulator 14, operates the mouse 1b and the keyboard 1c while referring to the state-transition matrix (FIG. 3) displayed on the display section 1a constituting the man-machine interface 1 and inputs information necessary to pseudo-generate each event (a technique of generating the event in accordance with a kind of actually, an each event or a like). Concerning kinds of events, there is an in-mail type in that an internal event generated in a cell of a state-transition matrix is notified to another state-transition matrix when a state-transition matrixes are layered, a function-call type in that a function for executing a group of processes is called in addition to the message-type, the flag-type event and the interrupt-type which are described above.

With this operation, the event pseudo-generating editor 3, based on the information necessary for pseudo generation input via the man-machine interface 1 (the technique of generating the event in accordance with each event, refers to information relative to the state-transition matrix memorized in the state-transition matrix memory section 4 and generates event pseudo-generating information which is information relative to an event to be pseudo-generated so as to memorized the event pseudo-generating information in the event pseudo-generating information memory section 5.

The generator 6 reads the information relative to the state-transition matrix from the state-transition matrix memory section 4 and reads the event pseudo-generating information from the event pseudo-generating information memory section 5, automatically generates a source program described in C language or a like based on these information and memorizes the source program in the program memory section 7, and automatically generates an event pseudo-generating routine for pseudo-generating an event and memorizes the event pseudo-generating routine in the event pseudo-generating routine memory section 8. The source program includes a main routine for executing main processes of the target system 16 and an event normal generating routine for notifying the main routine which key or switch is operated based on a signal supplied from the target system 16 by operating a key, a switch or a like in the target system 16 in accordance with the operation or based on various data and signals transmitted from another element such as a CPU or a semiconductor device, namely, for generating an event normally.

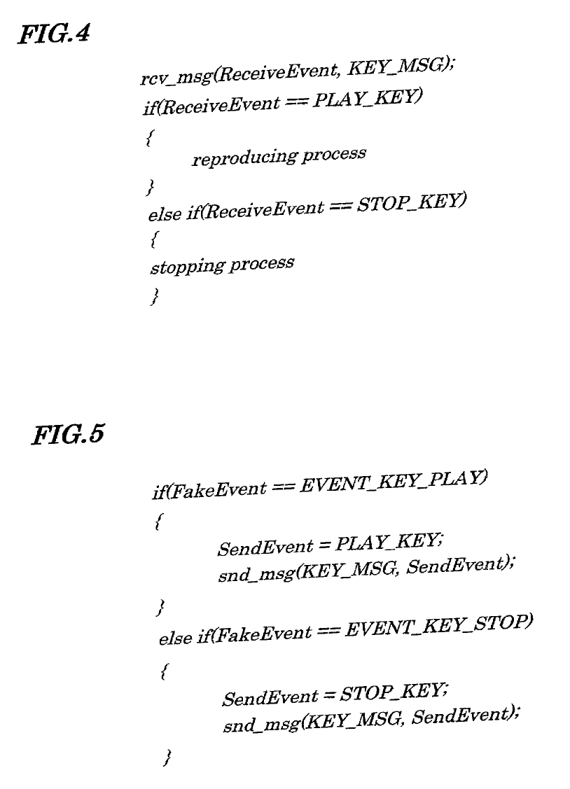

FIG. 4 and FIG. 5 show a part of the main routine described in C language and a part of the event pseudo-generating routine. In the part of the main routine shown in FIG. 4, a first line shows a system call of a real-time OS and indicates that a process is in a waiting state until a message is sent from the event normal generating routine or the event pseudo-generating routine to a message box KEY_MSG and contents of the message box KEY_MSG are stored in a variable ReceiveEvent when the message is received. In addition, a second line to fifth line indicate that the reproducing process of the music when the contents stored in the variable ReceiveEvent are equal to a constant PLAY_KEY indicating an input of a signal corresponding to the play key by pushing the play key by the user. Furthermore, a sixth line to ninth line indicate that the stopping process of reproducing of the music when contents stored in the variable ReceiveEvent are equal to a constant STOP_KEY showing an input of a signal corresponding to the stop key by pushing the stop key by the user.

Also, in the part of the event pseudo-generating routine, a first line to fifth line indicate that a constant PLAY_KEY is substituted in a variable SendEvent and then the variable SendEvent is transmitted to a message box KEY_MSG by a system call of the real-time OS when a content stored in a variable FakeEvent is equal to a value of a constant EVENT_KEY_PLAY indicating that an event similar to an event in which a signal corresponding to the play key is input by pushing the play key of by the user is pseudo-generated. Also, a sixth line to tenth line indicate that a constant STOP_KEY is substituted in the variable SendEvent and then the variable SendEvent is transmitted to the message box KEY_MSG by the system call of the real-time OS when a content stored in a variable FakeEvent is equal to a value of a constant EVENT_KEY_STOP indicating that an event similar to an event in which a signal corresponding to the stop key is input by pushing the stop key by the user is pseudo-generated.

Also, the event normal generating routine is approximately similar to the event pseudo-generating routine concerning basic functions except that, based on a signal or a like corresponding to the play key by pushing the play key transmitted from the keyboard 32 or a like via the housing 31, the emulation probe 15 and the I/O port 24, the variable SendEvent corresponding the signal is transmitted to the message box KEY_MSG by the system call of the real-time OS.

As described above, when the source program and the event pseudo-generating routine is described in c language and are memorized in the program memory section 7 and the event pseudo-generating routine memory section 8, the compiler 9 reads the source program described in C language from the program memory section 7, compiles the source program into an object program and memorizes it in the machine language code memory section 10.

Also, the compiler 9 reads the event pseudo-generating routine described in C language from the event pseudo-generating routine memory section 8, compiles the read event pseudo-generating routine into an event pseudo-generating routine described in a same machine language as the object program and memorizes it in the machine language code memory section 10. The object program and the event pseudo-generating routine described in the machine language and memorized in the machine language code memory section 10 are written in a ROM by a ROM writer, and the ROM is installed in the in-circuit emulator 14 as the ROM 22.

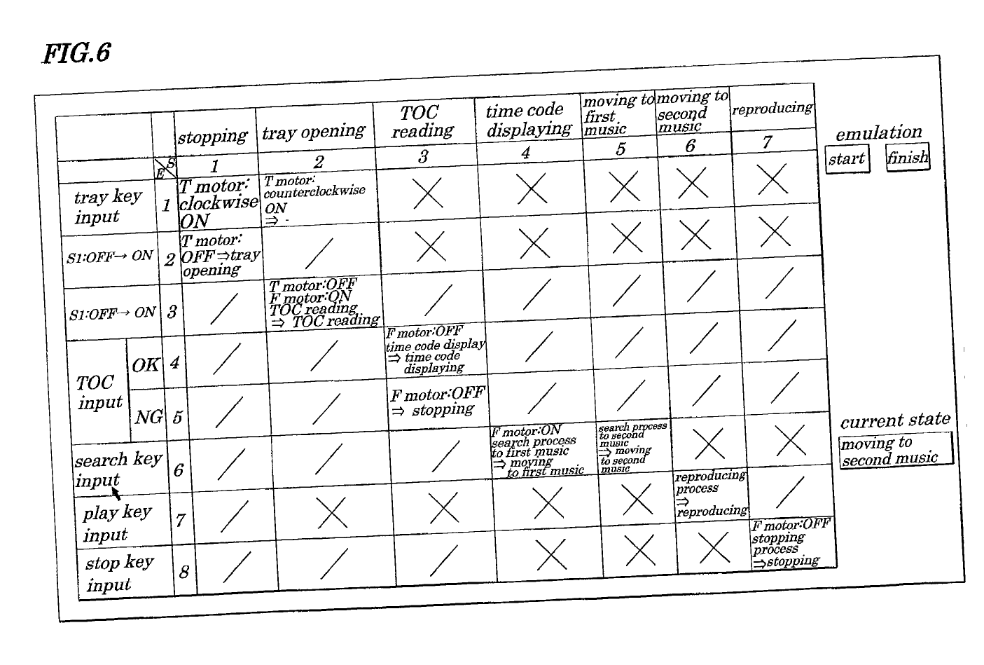

In a step that the ROM 22 in which the object program and the event pseudo-generating routine described in the machine language is installed in the in-circuit emulator 14, when the operator sets the program development apparatus in an emulation mode by operating the mouse 1b and the keyboard 1c to be the man-machine interface 1, an emulation mode screen shown in FIG. 6 is displayed on the display section 1a.

Hereafter, explanations will be given of operations of the input section 11, the analysis section 12, the debugger 13 and the in-circuit emulator 14 and of operations by the operator.

First, the operator moves the mouse 1b or the keyboard 1c to a “start” area instructing an emulation shown at a right-upper part of the emulation mode screen shown in FIG. 6 and clicks the left button or pushes the return key, and thereby starts the emulation.

Then, the operator moves the mouse 1b or the keyboard 1c to a display area of a state selected as an initial state of the emulation to be started (in this case, the “state 6” in that the tray 35 is drawn into the CD players the tray opening and shutting motor 49 is stopped, both of the spindle motor 48 and the filed motor 50 are driven and the top of the second piece of music is searched, “moving to second music” in FIG. 6) and clicks the left button or pushes the return key. With this operation, the input section 11 detects a position of the cursor in the display area of the state selected by the operator and supplies position information to the analysis section 12, and the analysis section 12 converts the position information supplied from the input section 11 into a state code corresponding to the position, namely, a code of the “state 6” in this case, and then controls the debugger 13 while setting a state corresponding to the state code (the state 6 in this case, “moving to second music” in FIG. 6 to the in-circuit emulator 14.

With this operation, the debugger 13 controls the in-circuit emulator 14 starts to execute a series of processes from the state set as the initial state, namely, in this case, from the “state 6” in that the tray 35 is drawn into the CD player, the tray opening and shutting motor 49 is stopped, both of the spindle motor 48 and the field motor 50 are driven and the top of the second piece of music is searched. In this case, it is assumed that the event pseudo-generating routine memorized in the ROM 22 together with the main routine and the event normal generating routine is periodically executed by a timer interruption or a like.

Then, when the operator moves the cursor with the mouse 1b or the cursor key of the keyboard 1c to a display area of the event of input of a signal corresponding to the play key which is pushed (“play key input” in FIG. 6) and clicks the left button or pushes the return key, the input section 11 detects a position of the cursor in the display area of the “event 7” and supplies position information to the analysis section 12. Therefore, the analysis section 12 converts the position information supplied from the input section 11 into an event code of the “event 7” corresponding to the position and, based on the event code, while referring to event pseudo-generating information read from the event pseudo-generating information memory section 5, controls the debugger 13, rewrites information used by the event pseudo-generating routine memorized in a predetermined area of the RAM 23 in the in-circuit emulator 14 and rewrites a value of the variable FakeEvent into a same value of the constant EVENT_KEY_PLAY which is a constant corresponding to the event code of the “event 7” in this case.

With this operation, since the event pseudo-generating routine, as shown in a first line to fifth line in FIG. 5, judges that a content stored in the variable FakeEvent is a same value of the constant EVENT_KEY_PLAY, the constant PLAY_KEY is assigned into the constant SendEvent and then the variable SendEvent is transmitted to the message box KEY_MSG by the system call of the real-time OS. In other words, the event pseudo-generating routine generates an event similar to the “event 7”.

Therefore, when the main routine, as shown in a first line to fifth line shown in FIG. 4, receives a message from the event pseudo-generating routine in the message box KEY_MSG, first, stores a content of the message box KEY_MSG in the variable ReceiveEvent and judges that the content of the ReceiveEvent is a same value of the constant PLAY_KEY indicating an input of the signal corresponding to the play key by pushing the play key by the operator, and therefore, the reproducing process of music is executed. In other words, the main routine requires the reproducing process of the second piece of music to the digital signal processing circuit 37 in order to reproduce the second piece of music.

In addition, following operations of the debugger 13 and the in-circuit emulator 14 are approximately similar those of the conventional debugger and the conventional in-circuit emulator, and therefore, explanations thereof will be omitted.

As described above, according to the first embodiment, only the operator moves the cursor with the mouse 1b or the cursor key of the keyboard 1c to a display area of the desirable event of occurrence among the plural events in the state-transition matrix displayed at the left side of the emulation mode screen shown in FIG. 6 and clicks the left button or pushes the return key, the event pseudo-generating routine pseudo-generates a same event as this event, in spite of a process which is first executed by operating plural switches and plural keys in order plural times, it is possible to test any process of the target system 16 in any order simply and in a short time without using hardware of the target system 16. As a result, it is possible to shorten a development period of the target system 16.

In addition, in FIG. 1 and FIG. 2, though the in-circuit emulator 14 is connected to the target system 16 via the emulation probe 15, this configuration is convenient for explanations or a like of the state-transition matrix shown in FIG. 3, and therefore, it is unnecessary to prepare the target system 16.

Whereas, in order to emulate the reproducing process of the second piece of music using the conventional program inspection apparatus in which it is necessary to actually operate switches or keys of the target system 16, it is necessary for the operator, in the target system 16 in a state in that the power is turned ON and the tray 35 on which no CD 55 is put is drawn into, to push the tray key again, to put the CD 55 on the tray 35 which is drawn out, to push the tray key again, to push the search key two times successively, and then to push the play key. As a result, it is troublesome and it takes a long time. When the above-mentioned series of processes are repeated many times, it is more troublesome and it takes even a longer time, and when prototype hardware of which durability is not considered is used, a switch or a button is easily broken. As a result, there is a possibility in that it hinders the test of the object program. Further, since only the reproducing process of the second piece of music can be tested after confirming all processes such as processes for drawing out and in the tray 35 until the reproducing process is executed and a process for searching the top of the second piece of music based on the operations of search key two times, flexibility of the test lacks.

### Second Embodiment

Next, a second embodiment of the present invention will be explained.

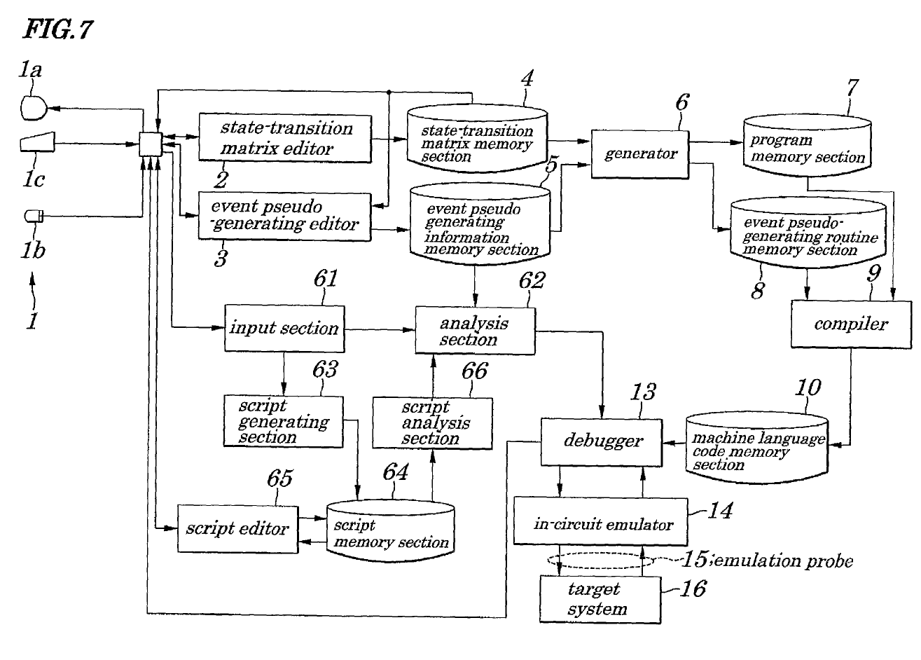

FIG. 7 is a block diagram showing a configuration of a program development apparatus according to the second embodiment of the present invention. In FIG. 7, same numerals are respectively given to same parts (components) as those in FIG. 1 and explanations thereof will be omitted. The program development apparatus in FIG. 7 is provided with an input section 61 and an analysis section 62 instead of an input section 11 and an analysis section 12 in FIG. 1 and is newly provided with a script generating section 63, a script memory section 64, a script editor 65 and a script analysis section 66.

The input section 61, in addition to a function of the input section 11 shown in FIG. 1, is provided with a function for memorizing an order of events selected with a mouse 1b or a keyboard 1c by an operator and an input timing of each event (hereafter, called an input event log) in an internal memory and then for supplying the input event log to the script generating section 63. The script generating section 63, based on the input log supplied from the input section 61, generates a script file and memorizes it in the script memory section 64. The script file is a file of a timing chart format, a text format or a message sequence chart format in which an order and an occurrence timing of generating each order, a timing of which elements in the target system 16 should be operated according to specifications or a like is described in order to execute an emulation based on the state-transition matrix of a target system 16 designed by the state-transition matrix. The script memory section 64 is a semiconductor memory such as a RAM or a storage medium of a large storage capacity, such as an FD or a HD and memorizes the script file.

The script editor 65, based on an event which should be occurred so as to execute the emulation input using an man-machine interface 1, an occurrence timing of the event or an occurrence frequency, edits the script file read from the script memory section 64 and then memorizes it in the script memory section 64 again. The script analysis section 66 sequentially supplies position information of each event described in the script file read from the script memory section 64 in a corresponding display area of the state-transition matrix displayed on a display section 1a to the analysis section 62 in order and at a timing described in the script file. The analysis section 62, in addition to a function of the analysis section shown in FIG. 1, is provided with a function for converting position information supplied from the script analysis section 66 into an event code corresponding to the position and for referring to the event pseudo-generating information read from an event pseudo-generating information memory section 5 based on the event code, controlling the debugger 13, rewriting the information used by the event pseudo-generating routine memorized in the predetermined memory area of a RAM 23 (FIG. 2) in an in-circuit emulator 14 and thereby pseudo-generating an event corresponding to the event code.

Next, explanations will be given of operations of the configuration different from that of the first embodiment among the operations of the program development apparatus. First, the operator sets the program development apparatus into the emulation mode and, in a step in which the “state 6” is set as an initial state, moves the cursor to the display area of the “event 7” (“play key input” in FIG. 6) in that a signal corresponding to the play key is input by pushing the play key among a plurality of events in the state-transition matrix displayed at the left side of the emulation mode shown in FIG. 6 with the mouse 1b or the cursor key of the keyboard 1c and clicks the left button of the mouse or pushes the return key.

With this operation, the input section 61 detects a position of the cursor in the display area of the “event 7”, supplies the position information to the analysis section 62, temporarily memorizes the input event log which is a timing of the event 7 and an input timing in the internal memory, and then supplies the input event log to the script generating section 63. Therefore, the script generating section 63, based on the input event log which is the timing of the “event 7” and the input timing supplied from the input section 61, generates a script file for generating the “event 7” once and memorizes the script file into the script memory section 64.

Therefore, when the program development apparatus is made to execute the same emulation successively, the operator only makes the script analysis section 66 read the script file from the script memory section 64 and supplies the position information of the “event 7” described in the script file in a corresponding display area in the state-transition matrix displayed on the display section 1a at the occurrence timing described in the script file without moving the cursor to the display area of the “event 7” in the state-transition matrix displayed at the left side of the emulation mode screen again. As a result, the analysis section 62 converts the position information into the event code corresponding to the position and, based on the event code, refers to the event pseudo-generating information read from the event pseudo-generating information memory section 5, controls the debugger 13 and rewrites the information used by the event pseudo-generating routine memorized in the predetermined storage area of the RAM 23 in the in-circuit emulator 14, and thereby the “event 7” corresponding to the event code is pseudo-generated.

Also, when the program development apparatus is made to times, the operator, first, operates the mouse 1b or the keyboard 1c while referring to display on the display section 1a in the man-machine interface 1, makes the script editor 65 read the script file from the script memory section 64 so as to display the script file on the display section 1a, and changes an occurrence frequency from once to one hundred times. With this operation, the script editor 65 changes the occurrence frequency of the “event 7” of the script file read from the script memory section 64 from once to one hundred times and then memorizes the script file in the script memory section 64 again. Then, the operator makes the script analysis section 66 read a new script file from the script memory section 64 and instructs to supply the position information of the “event 7” described in the script file in a corresponding display area in the state-transition matrix displayed on the display section 1a at the occurrence timing and the occurrence frequency (one hundred times in this case) described in the script file. With this operation, the analysis section 62 converts the position information supplied from the script analysis section 66 into an event code corresponding to the event code and, based on the event code, refers to the event pseudo-generating information read from the event pseudo-generating information memory section 5, controls the debugger 13 and rewrites the information used by the event pseudo-generating routine memorized in the predetermined storage area of the RAM 23 in the in-circuit emulator 14 and thereby the “event 7” corresponding to the event code is pseudo-generated one hundred times.

As described above, according to the second embodiment, it is possible to execute generating of the script file and the emulation and it is possible to shorten a time for generating the script file and a time for the emulation, and therefore, it is possible to shorten a development period of the object program.

Also, according to the second embodiment, in spite of the complication of hardware of the target system 16 and in spite of the process which is first executed after operating switches or keys plural times in order, it is possible to repeat the emulation any number of times automatically, and therefore, it is possible to shorten the development period of the object program.

Further, according to the second embodiment, in spite of that the object program must be widely re-tested since there is a bug at a position in the object program as a result of a program test, the bug is corrected but the correction puts another position to a trouble and degradation which a whole quality of the object program occurs, it is possible to automatically pseudo-generate a plurality of events widely by generating the script file. Therefore, it is also possible to shorten the development period of the object program.

It is apparent that the present invention is not limited to the above embodiments but may be changed and modified without departing from the scope and spirit of the invention.

For example, in the first embodiment and the second embodiment, the in-circuit emulator 14 is mainly provided with the evaluation chip 21, the ROM 22, the RAM 23 and the I/O port 24 and is connected with the target system 16 via the emulation probe 15 by engaging the housing 31 in the target system 16 with the CPU socket provided at the top of is engaged the emulation probe 15, however, the present invention is not limited to this. For example, in order to cope with a high-speed CPU, an evaluation chip is provided on the emulation probe of which an end is connected to an in-circuit emulator, the emulation probe is engaged with a housing into which a real chip installed on a print substrate forming hardware of a target system is inserted, and thereby the in-circuit emulator and the hardware of the target system may be connected via the emulation probe. In this case, as the hardware of the target system, a ROM in which an object program to be tested is stored and a print substrate on which a RAM used in executing the object program is mounted are needed at least. Also, in order to test the object program in a near real state, not an evaluation chip but a chip may be used in which a circuit, a memory and a terminal at least needed for trace are provided on a CPU chip of an internal structure and a number of terminals similar those of the real chip. In this case, as the hardware of the target system, the CPU chip of the above-described structure, a ROM in which an object program to be tested is memorized and a print substrate on which a RAM used in executing the object program are needed at least, an in-circuit emulator is unnecessary and the CPU chip and the debugger may be connected via a probe.

In the first embodiment and the second embodiment, the source program and the event pseudo-generating routine described in the programming language are described in C language, however, the present invention is not limited to this. Also, in the event pseudo-generating routine described in the programming language, “snd_msg” and “rcv_msg” are examples in a notifying technique among a plurality of notifying techniques, and any notifying technique maybe used. For example, instead of the simple variable (SendEvent), a structure of a plurality of variables may be used and the system call of a real-time OS may not used.

Furthermore, in the first embodiment and the second embodiment, each section is represented by hardware, however, the present invention is not limited to this. In other words, the program development apparatus may be a computer including a CPU, internal storage units such as a ROM and a RAM, external storage units such as an FDD (Floppy Disk Driver), a HDD (Hard Disk Driver) and a CD-ROM driver, an input unit and an output unit. The state-transition matrix editor 2, the event pseudo-generating editor 3, the generator 6, the compiler 9, the input section 11 (61), the analysis section 12 (62), the debugger 13, the script generating section 63, the script editor 65, the script analysis section 66 and a like are carried out by the CPU, and these functions may be memorized in a semiconductor memory such as a ROM, a storage medium such as an FD, an HD and a CD-ROM as a program development program. In this case, the internal storage unit or the external storage unit becomes the state-transition matrix memory section 4, the event pseudo-generating information memory section 5, the program memory section 7, the event pseudo-generating routine memory section 8, the machine language code memory section 10, the script memory section 64 and a like. The program development program is read from the storage medium into the CPU and controls the operation of the CPU. When the program development program is started, the CPU functions as the state-transition matrix editor 2, the event pseudo-generating editor 3, the generator 6, the compiler 9, the input section 11 (61), the analysis section 12 (62), the debugger 13, the script generating section 63, the script editor 65, the script analysis section 66 and a like, and the above-described processes are executed by control of the program development program.

What is claimed is:

1. A program development apparatus used for developing a program to be installed in a system having at least a first central processing and an other component, said program development apparatus comprising:
a program generating section for generating said program and an event pseudo-generating routine for pseudo-generating said event based on a state-transition matrix and event pseudo-generating information for pseudo-generating a same event as an event which normally occurs based on data or a signal transmitted from said other component to said first central processing unit in said system, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell;
a second central processing unit having a same function as said first central processing unit and for executing emulation of said program and said event pseudo-generating routine; and
an analysis section for starting said emulation of said program from a state input as an initial state and for referring to said pseudo-generating information and rewriting information for pseudo-generating said event memorized in a memory section used in executing said event pseudo-generating routine into information corresponding to said event which is instructed to occur.

2. A program development apparatus used for developing a program to be installed in a system having at least a first central processing and an other component, said program development apparatus comprising:
a state-transition matrix memory section for memorizing a state-transition matrix, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell;
an event pseudo-generating editor for generating event pseudo-generating information for pseudo-generating a same event as an event which normally occurs based on data or a signal transmitted from said other component to a first central processing unit in said system;
a program generating section for generating said program and an event pseudo-generating routine for pseudo-generating said event;
a second central processing unit for having a same function as said first central processing unit and for executing emulation of said program and said event pseudo-generating routine;
an input section for detecting which display position of each event or each state is indicated among a plurality of events and a plurality of states forming said state-transition matrix displayed on a display section and for outputting position information of said display position; and
an analysis section for converting said position information into an event code or a state code corresponding to said position so as to set a state corresponding to said state code as an initial state for starting emulation of said program and for referring to said pseudo-generating information so as to rewrite information memorized in a memory section used in executing said pseudo-generating routine, said information for pseudo-generating an event into information corresponding to said event code.

3. A program development apparatus used for developing a program to be installed in a system having at least a first central processing and an other component, said program development apparatus comprising:
a state-transition matrix memory section for memorizing a state-transition matrix, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell;
an event pseudo-generating editor for generating event pseudo-generating information for pseudo-generating a same event as an event which normally occurs based on data or a signal transmitted from said other component to a first central processing unit in said system;
a program generating section for generating said program and an event pseudo-generating routine for pseudo-generating said event;
a second central processing unit for having a same function as said first central processing unit and for executing emulation of said program and said event pseudo-generating routine;
an input section for detecting which display position of each event or each state is indicated among a plurality of events and a plurality of states forming said state-transition matrix displayed on a display section so as to output position information of said display position and for generating an input event log including an order of instructed events and an instruction timing of each event; and
a script generating section for generating a script file in which an occurrence timing of each event and a timing at which an element in said system operates in accordance with a specification are descried based on said input event log;
a script analysis section for sequentially outputting position information of each event described in said script file and of a corresponding display area in said state-transition matrix displayed on said display section in order and at an occurrence timing described in said script file; and
an analysis section for converting said position information into an event code or a state code corresponding to said position so as to set a state corresponding to said state code as an initial state for starting emulation of said program and for referring to said pseudo-generating information so as to rewrite information memorized in a memory section used in executing said pseudo-generating routine, said information for pseudo-generating an event into information corresponding to said event code.

4. The program development apparatus according to claim 3 further comprising:
a script editor for editing said script file based on any one of an event input to be occurred, an occurrence timing of said event and an occurrence frequency.

5. The program development apparatus according to claim 3, wherein said script file is any one of a timing chart format, a text format and a message sequence chart format.

6. The program development apparatus according to claim 1, wherein said program includes a main routine for executing a main process of said system and a normal generating event routine for normally generating a corresponding event based on various data and a signal transmitted from said other component to said first central processing unit.

7. The program development apparatus according to claim 2, wherein said program includes a main routine for executing a main process of said system and a normal generating event routine for normally generating a corresponding event based on various data and a signal transmitted from said other component to said first central processing unit.

8. The program development apparatus according to claim 3, wherein said program includes a main routine for executing a main process of said system and a normal generating event routine for normally generating a corresponding event based on various data and a signal transmitted from said other component to said first central processing unit.

9. The program development apparatus according to claim 1, wherein said event pseudo-generating information is information of a generating technique in accordance with said event.

10. The program development apparatus according to claim 2, wherein said event pseudo-generating information is information of a generating technique in accordance with said event.

11. The program development apparatus according to claim 3, wherein said event pseudo-generating information is information of a generating technique in accordance with said event.

12. The program development apparatus according to claim 1, wherein said event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of said state-transition matrix to another state-transition matrix when said state-transition matrix is layered and a function-call type for calling a function executing a group of processes.

13. The program development apparatus according to claim 2, wherein said event is any one of a message-type for receiving a start message from another task or another apparatus, a flag-type for reading a variation of a variable or an input/output, an interrupt-type for receiving an interrupt from an outside, an matrix when said state-transition matrix is layered and a function-call type for calling a function executing a group of processes.

14. The program development apparatus according to claim 3, wherein said event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of said state-transition matrix to another state-transition matrix when said state-transition matrix is layered and a function-call type for calling a function executing a group of processes.

15. A program development method used for developing a program to be installed in a system having at least a first central processing and an other component, said program development method comprising:
a first step of generating said program and an event pseudo-generating routine for pseudo-generating said event based on a state-transition matrix and event pseudo-generating information for pseudo-generating a same event as an event which normally occurs based on data or a signal transmitted from said other component to said first central processing unit in said system, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell; and
a second step of starting emulation of said program from a state input as an initial state, of referring to said pseudo-generating information while executing said event pseudo-generating routine and of rewriting information for pseudo-generating said event memorized in a memory section used in executing said event pseudo-generating routine into information corresponding to said event which is instructed to occur.

16. A program development method used for developing a program to be installed in a system having at least a first central processing and an other component, and carried out by using:
a state-transition matrix memory section for memorizing a state-transition matrix, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell;
an input section for detecting a display position of which event or state is instructed among a plurality of events or a plurality of states forming said state-transition matrix displayed on a display section and for outputting position information about detected said display position, said program development method comprising:
a first step of generating event pseudo-generating information for pseudo-generating a same event as an event normally generated based on data or a signal transmitted from said other component to a first central processing unit in said system;
a second step of generating said program and an event pseudo-generating routine for pseudo-generating said event based on said state-transition matrix and said event pseudo-generating information; and
a third step of converting said position information into an event code or a state code corresponding to said position, of starting emulation of said program from a state input as an initial state, of referring to said pseudo-generating information while executing said event pseudo-generating routine and of rewriting information for pseudo-generating said event memorized in a memory section used in executing said event pseudo-generating routine into information corresponding to said event which is instructed to occur.

17. A program development method used for developing a program to be installed in a system having at least a first central processing and an other component, and carried out by using:
a state-transition matrix memory section for memorizing a state-transition matrix, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell;
an input section for detecting a display position of which event or state is instructed among a plurality of events or a plurality of states forming said state-transition matrix displayed on a display section and for outputting position information about detected said display position, said program development method comprising:
a first step of generating event pseudo-generating information for pseudo-generating a same event as an event normally generated based on data or a signal transmitted from said other component to a first central processing unit in said system;
a second step of generating said program and an event pseudo-generating routine for pseudo-generating said event based on said state-transition matrix and said event pseudo-generating information;
a third step of generating an input event log including an order of instructed events and a timing at which each event is instructed;
a fourth step, based on said input event log, of generating a script file in which an occurrence timing of each event described in said state-transition matrix and a timing at which an element in said system operates in accordance with a specification are described;
a fifth step of sequentially outputting position information of each event described in said script file and of a corresponding display area in said state-transition matrix displayed on said display section in order and at an occurrence timing described in said script file; and
a sixth step of converting said position information into an event code corresponding to said position, of referring to said event pseudo-generating information while executing said event pseudo-generating routine and of rewriting information memorized in a memory section used by said event pseudo-generating routine, said information for pseudo-generating an event into information corresponding to said event code.

18. The program development method according to claim 17, further comprising:
a seventh step of editing said script file based on any one of an event input to be occurred, an occurrence timing of said event and an occurrence frequency.

19. The program development method according to claim 17, wherein said script file is any one of a timing chart format, a text format and a message sequence chart format.

20. The program development method according to claim 15 wherein said program includes a main routine for executing a main process of said system and a normal generating event routine for normally generating a corresponding event based on various data and a signal transmitted from said other component to said first central processing unit.

21. The program development method according to claim 16 wherein said program includes a main routine for executing a main process of said system and a normal generating event routine for normally generating a corresponding event based on various data and a signal transmitted from said other component to said first central processing unit.

22. The program development method according to claim 17 wherein said program includes a main routine for executing a main process of said system and a normal generating event routine for normally generating a corresponding event based on various data and a signal transmitted from said other component to said first central processing unit.

23. The program development method according to claim 15, wherein said event pseudo-generating information is information of a generating technique in accordance with said event.

24. The program development method according to claim 16, wherein said event pseudo-generating information is information of a generating technique in accordance with said event.

25. The program development method according to claim 17, wherein said event pseudo-generating information is information of a generating technique in accordance with said event.

26. The program development method according to claim 15, wherein said event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of said state-transition matrix to another state-transition matrix when said state-transition matrix is layered and a function-call type for calling a function executing a group of processes.

27. The program development method according to claim 16, wherein said event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of said state-transition matrix to another state-transition matrix when said state-transition matrix is layered and a function-call type for calling a function executing a group of processes.

28. The program development method according to claim 17, wherein said event is any one of a message-type for receiving a start message from another task or another apparatus, a flag-type for reading a variation of a variable or an input/output, an interrupt-type for receiving an interrupt from an outside, an in-mail type for notifying an internal event which occurs in a cell of said state-transition matrix to another state-transition matrix when said state-transition matrix is layered and a function-call type for calling a function executing a group of processes.

29. A program development program for causing a computer to carry out a program development method used for developing a program to be installed in a system having at least a first central processing and an other component, said program development method comprising:
a first step of generating said program and an event pseudo-generating routine for pseudo-generating said event based on a state-transition matrix and event pseudo-generating information for pseudo-generating a same event as an event which normally occurs based on data or a signal transmitted from said other component to said first central processing unit in said system, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell; and
a second step of starting emulation of said program from a state input as an initial state, of referring to said pseudo-generating information while executing said event pseudo-generating routine and of rewriting information for pseudo-generating said event memorized in a memory section used in executing said event pseudo-generating routine into information corresponding to said event which is instructed to occur.

30. A storage medium storing a program development program for causing a computer to carry out a program development method used for developing a program to be installed in a system having at least a first central processing and an other component, said program development method comprising:
a first step of generating said program and an event pseudo-generating routine for pseudo-generating said event based on a state-transition matrix and event pseudo-generating information for pseudo-generating a same event as an event which normally occurs based on data or a signal transmitted from said other component to said first central processing unit in said system, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell; and
a second step of starting emulation of said program from a state input as an initial state, of referring to said pseudo-generating information while executing said event pseudo-generating routine and of rewriting information for pseudo-generating said event memorized in a memory section used in executing said event pseudo-generating routine into information corresponding to said event which is instructed to occur.

31. A program development program for causing a computer to carry out a program development program for causing a computer to carry out A program development method used for developing a program to be installed in a system having at least a first central processing and an other component, said program development method comprising:
a state-transition matrix memory section for memorizing a state-transition matrix, wherein said state-transition matrix has a plurality of cells, each of said cells defined by a state in which said system to be a subject of a program development is enabled to be and an event which is an impulse from an outside or an inside of said system and further wherein a content of a process to be executed by said system and a state of a transition destination to be transited when a corresponding event occurs under a corresponding state are described in each said cell;
an input section for detecting a display position of which event or state is instructed among a plurality of events or a plurality of states forming said state-transition matrix displayed on a display section and for outputting position information about detected said display position;
a first step of generating event pseudo-generating information for pseudo-generating a same event as an event normally generated based on data or a signal transmitted from said other component to a first central processing unit in said system;
a second step of generating said program and an event pseudo-generating routine for pseudo-generating said event based on said state-transition matrix and said event pseudo-generating information; and
a third step of converting said position information into an event code or a state code corresponding to said position, of starting emulation of said program from a state input as an initial state, of referring to said pseudo-generating information while executing said event pseudo-generating routine and of rewriting information for pseudo-generating said event memorized in a memory section used in executing said event pseudo-generating routine into information corresponding to said event which is instructed to occur.
